(19) United States
(12) Patent Application Publication
(10) Pub. No.: US 2019/0026360 A1
(43) Pub. Date: Jan. 24, 2019

(54) DATA PROCESSING USING AN ENUMERATION UTILITY

(71) Applicant: GM Global Technology Operations LLC, Detroit, MI (US)

(72) Inventor: John P. Carroll, Royal Oak, MI (US)

(21) Appl. No.: 15/653,238

(22) Filed: Jul. 18, 2017

(51) Int. Cl. G06F 17/30

(52) U.S. Cl. CPC G06F 17/30607; G06F 17/30327; G06F 17/30386; G06F 17/30067

(57) ABSTRACT

A system and method for carrying out one or more commands on one or more selected data objects contained in a set of data objects, wherein the method comprises the steps of: determining a hierarchy of a set of data objects, wherein the set of data objects comprises a plurality of data objects that are organized in a hierarchical structure containing one or more hierarchical levels; receiving an object selection identifying one or more selected data objects; receiving a command input, wherein the command input identifies one or more commands to be carried out on the one or more selected data objects; and carrying out the one or more commands on the one or more selected data objects by traversing the set of data objects based on the determined hierarchy of the set of data objects.

The invention relates to carrying out one or more commands on selected data objects that are part of a file storage and management system.

With a growing number of computers, data networks collect, store, and communicate an increasing amount of data. The use of file management systems may allow for large data and document collections to be more easily organized, maintained, and stored. These file systems may store data that is organized in certain hierarchical structures, such as trees, or using other relational models. In some instances, the data may be stored in one or more databases and accessible by a user through use of the file system interface or other associated interface. The user may carry out certain commands on certain data objects. The commands may be included as part of the file system, may be developed and written by the user or third party, or may comprise a combination thereof.

### SUMMARY

According to an embodiment of the invention, there is provided a method for carrying out one or more commands on one or more selected data objects contained in a set of data objects, wherein the method comprises the steps of: determining a hierarchy of a set of data objects, wherein the set of data objects comprises a plurality of data objects that are organized in a hierarchical structure containing one or more hierarchical levels; receiving an object selection identifying one or more selected data objects; receiving a command input, wherein the command input identifies one or more commands to be carried out on the one or more selected data objects; and carrying out the one or more commands on the one or more selected data objects by traversing the set of data objects based on the determined hierarchy of the set of data objects.

According to another embodiment of the invention, there is provided a method for carrying out a command on one or more selected data objects contained in a set of data objects, wherein the method comprises the steps of: identifying a set of data objects based on a connection to a file management system, wherein the set of data objects comprises a plurality of data objects that are organized in a hierarchical structure containing a plurality of hierarchical levels and wherein the set of data objects are accessible via the file management system; evaluating the set of data objects to determine one or more hierarchical levels of the data objects comprising the set of data objects; receiving an object selection input indicating one or more selected data objects, wherein the object selection input specifies either at least one data object or at least one of the plurality of hierarchical levels; receiving a command input indicating a command to be carried out on the selected data objects, wherein the selected data objects are either those data objects specified in the object selection input or those data objects included in the hierarchical level specified in the object selection input; and carrying out the command on the one or more selected data objects by traversing the set of data objects based on the one or more hierarchical relationships.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting an embodiment of a communications system and a data system that is capable of utilizing the method disclosed herein;

FIG. 2 is a block diagram depicting an embodiment of a set of data objects that may be stored at a data system;

FIG. 3 is a block diagram depicting an embodiment of a graphical user interface (GUI) for use with the methods disclosed herein;

FIG. 4 is a flowchart illustrating an embodiment of a method for carrying out one or more commands on one or more selected data objects contained in a set of data objects;

FIG. 5 is a flowchart illustrating an embodiment of a method for locating and identifying code assemblies or commands that may be carried out on one or more data objects;

FIG. 6 is a flowchart illustrating an embodiment of a method of providing a graphical user interface for selecting input and/or configuring options for an enumeration job; and

FIG. 7 is a flowchart illustrating an embodiment of a method for carrying out one or more commands on one or more selected data objects contained in a set of data objects.

### DETAILED DESCRIPTION

The system and methods described below enable one or more commands to be carried out on one or more selected data objects contained in a set of data objects that is organized or arranged in a hierarchical structure. In one embodiment, the set of data objects are traversed to locate the selected data objects; in other embodiments, the selected data objects are located via a memory address, identifier, or other locating means, as discussed below. The method generally includes the steps of: evaluating the set of data objects to determine the hierarchical structure of the set of data objects; receiving an object selection identifying one or more selected data objects; receiving a command input containing one or more commands to be carried out on the selected data objects; and carrying out the command(s) on the selected data objects through traversing the hierarchy based on the evaluation.

A user may connect to a file or document management and storage system (“file system” or “file management system”) using a client computing device thereby gaining access to a set of data objects that are organized into a hierarchical structure, such as a tree structure. The hierarchical structure contains multiple hierarchical levels and each data object can be associated with a certain hierarchical level. One such file system, Microsoft™ SharePoint™ provides certain hierarchical structures to organize documents, files, and data, and, at least in one embodiment, provides the following hierarchy in top-down order: farms, web applications (“web apps”), site collections (which may be organized into a content database, as will be discussed below), sites, lists, and items.

In on embodiment, a user who is using Microsoft™ SharePoint™ may establish a connection with a SharePoint™ thereby gaining access to one or more sets of SharePoint™ data objects. The connection may be detected and the data objects associated with the connection may be determined based on the connection. Or, in another embodiment, a user may provide a reference to a certain set of data objects included in their SharePoint™ environment. This set of data objects may be evaluated to determine a hierarchical structure of the set of data objects. Then, a user may then select certain data objects from that set of data objects along with certain commands. Having already received input indicating the set of data objects, a command, and the selected data objects for which to carry out the command, the set of data objects can be traversed based on the evaluation to locate the selected objects such that it may carry out the command(s) on these selected objects.

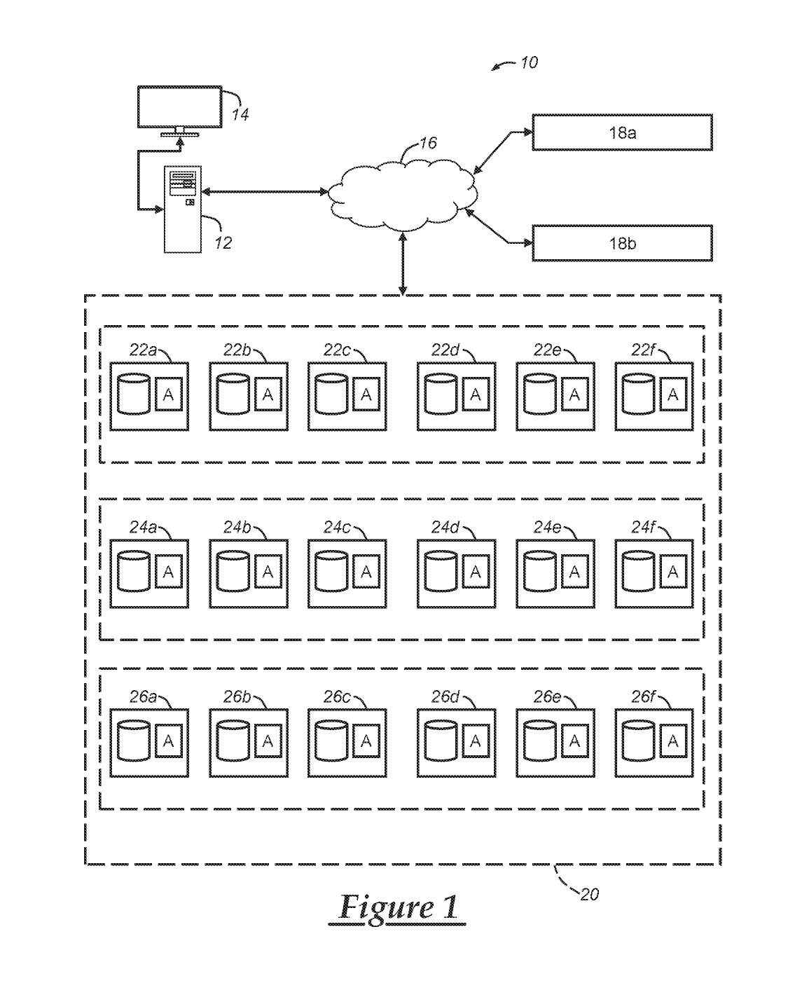

Referring now to FIG. 1, there is shown an operating environment that comprises a communications system 10 and that can be used to implement the method disclosed herein. Communications system 10 generally includes one or more computers 12, a land communications network 16, one or more remote locations 18, and one or more data systems 20. It should be understood that the disclosed method can be used with any number of different systems and is not specifically limited to the operating environment shown here. Also, the architecture, construction, setup, and operation of the system 10, namely the data systems 20, and its individual components are generally known in the art. Thus, the following paragraphs simply provide a brief overview of one such communications system 10 and data system 20; however, other systems not shown here could employ the disclosed method as well.

Land network 16 may be a conventional land-based telecommunications network that is connected to one or more landline telephones and can connect one or more wireless carrier systems (not shown) to data system 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof.

Computers 12 (only one shown) can be some of a number of computers accessible via a private or public network such as the Internet. Each computer may be a personal computer that includes a visual display 14 and which may include other user interfaces, such as a keyboard, a mouse, a microphone, and/or a video camera. The computer may also include a networking chipset that enables the computer to communicate with other computers, servers, or devices, such as front-end servers 26 at data system 20. The computer may be physically or wirelessly connected to a router or modem which may be used for network communications with remote networks via land network 16. A user may also access remote networks or devices via a browser application, file explorer, or other client software. Additionally, a user may carry out certain computer instructions or software on data located at other remote networks, such as running or operating an enumeration utility on data located at data system 20, as will be discussed below. Each computer 12 may send messages or data to data system 20 and receive messages or data from data system 20.

Each such computer 12 can be used for one or more purposes, such as for providing access to content stored at a data system 20. As will be discussed in more detail below, computers 12 may be client computing devices that allow a user to access a web application hosted by a front-end server 26 via a browser or other network application on computer 12. The web application may provide an interface between a user at a computer 12 and content stored in content servers 22. The user may connect to a front-end server 26 via operating a browser or other application at computer 12. For example, a user may connect to a web application running on a front-end server 26 via use of a hypertext transfer protocol (HTTP) on a browser. Subsequently, the web application may serve responses to requests from the browser thereby providing a web application to the user. In another embodiment, the computer 12 may have one or more dedicated applications stored thereon that may function, at least in part, through communicating with a web application running on a front-end server 26. For example, an enumeration utility program can be stored on a computer 12. When the program is executed, a graphical user interface of the enumeration utility can be displayed on a visual display 14.

Remote locations 18a,b may include one or more switches, servers, databases, or other computer systems. Each remote location 18 may include any or all of these various components and, preferably, each of the various components are coupled to one another via a wired or wireless local area network. Remote locations 18 may receive and transmit data via a modem connected to land network 16, computers 12, and data systems 20. In some embodiments, remote locations 18 may be a data system and may coordinate communications and operations with other data systems, such as data system 20. In other embodiments, remote locations 18 may be computers and/or Internet accessible servers or networks.

The data system 20 may include one or more computers, databases, servers, or devices, and provides the system with data storage capabilities. Data system 20 may communicate with computers 12, remote locations 18, or other devices or systems that may be connected to a land network 16, such as devices or systems that are accessible over the Internet or other remote network. Data system 20 is a collection of servers or computers that are configured such that they include content servers 22a-f, application servers 24a-f, and front-end servers 26a-f. In one embodiment, data system 20 may operate a file system. A file system, as used herein, is any system that may manage and store data using one or more computing devices. In one embodiment, Microsoft™ SharePoint™ may constitute a file system that is implemented using data system 20 and/or computers 12. In such an embodiment, SharePoint™ may be used to manage and store documents and files at data system 20. Although a specific arrangement of devices is shown in FIG. 1, it should be appreciated that this is but one arrangement and that there are numerous different possible arrangements of data system 20 and its components. For example, as mentioned above, remote locations 18 may also be data systems similar to data system 20. Also, the content servers, application servers, and front-end servers may be co-located at the same location or may be located at different facilities or locations.

Each content server 22 includes an electronic computing device, such as a computer or server, and one or more memory mediums for storing data or databases. The content servers 22a-f may include networking capabilities so that information may be shared among the various content servers 22a-f. For example, content server 22a may communicate with content server 22d via a local interconnection network (LIN), a local area network (LAN), and other appropriate connections such as Ethernet or others that conform with known ISO, SAE and IEEE standards and specifications, to name but a few. Moreover, any of the content servers 22a-f may communicate with one or more of the application servers 24a-f and/or front-end servers 26a-f in a similar manner.

As mentioned, one or more databases may be stored at each of the content servers. The databases may be grouped together based on certain hierarchical levels and/or relationships. For example, in one embodiment where a SharePoint™ environment is used to manage documents and data, there may be multiple farms that each contain certain web apps and the web apps may each contain certain site collections. Each content server may include one or more content databases and the content databases of the content servers may be grouped together based on the farms, web apps, or site collections. In one embodiment, there may be one content database for storing content of each of the site collections—a one-to-one correspondence of content databases to site collections; however, other relationships are possible, such as a one-to-many relationship of content databases to site collections.

Database management software can be installed on the computing devices of the content servers 22a-f, which allows the content servers to perform operations on the data stored at the content servers. In one embodiment, the content servers 22 may use Microsoft™ SQL Server. Additionally, the database management software can provide an interfacing means for other computers, servers, or devices to store and retrieve data from the data stored on the memory of the content servers. For example, when a request for certain data is received at a content server, the content server may use the database management software to query the database to retrieve the requested data, which may then be sent to some destination, such as application server 24, front-end server 26, or computer 12, in response to the request. In some embodiments, there may be one or more central computers that store and/or execute the database management software. Moreover, although each content server is illustrated as a database object cylinder representing a database and an “A” representing an application, each content server may include numerous databases, tables, partitions of databases, applications, instruction sets, firmware, and/or software. The same is true for the applications servers 24 and front-end servers 26, which are described below.

Each application server 24 includes an electronic computing device, such as a computer or server, and one or more memory mediums for storing data or databases. The application servers 24 may contain networking capabilities similar to those described above with respect to the content servers 22. The application servers can receive and respond to network requests from remote devices or computers, such as computers 12 via land network 16. Additionally, other servers or devices co-located at the data system 20 may communicate with the application servers 24. The application servers may request data from content servers 22 and then perform operations, such as executing certain software programs, on the data or using the data. The application servers 24 may prepare data for insertion into the databases at content servers 22 and/or otherwise process data for other purposes.

The application servers 24 may process data located in content servers 22. In one embodiment, the application servers 24 can carry out certain algorithms, code assemblies, or other instructions (collectively, “commands”) on data stored in the content databases of content servers 22. As will be discussed below in further detail, an enumeration utility may be used to facilitate a user's operation in carrying out certain commands. Additionally, the application servers 24 may assist the front-end servers 26 in carrying out certain process, some of which may be more memory-intensive or require more processing power than other operations. For example, the application servers 24 may assist in performing searches and/or other intensive queries on the data stored in the databases at the content servers 22.

In some embodiments, the commands may be carried out in numerous threads, which may be executed in a concurrent or multithreaded manner. As used herein, a concurrent or multithreaded manner means that the threads are carried out in an asynchronous or multithreaded fashion, which includes synchronous multithreaded processing techniques. In some instances, each thread may process the data objects contained in a single file at a given time. For example, if there are ten data files with each data file having 5 data objects, then there may be ten threads with each thread processing the 5 data objects in a given data file. The number of threads running at any given time may be monitored. Also, a thread maximum may be specified at a GUI by a user, in one or more of the commands, or at some other location. Upon a thread completing the processing of a data file, the thread may start processing a next data file. Or, the thread may terminate and a new thread may be started and executed to process a next data file.

Front-end servers 26 each include an electronic computing device, such as a computer or server, and one or more memory mediums for storing data or databases. The front-end servers may host a web application that operates to process network requests from a remote network device, such as computer 12 or other device that may be located at a remote location 18. The web application may operate to provide a computer 12 with access to content stored at content servers 22. For example, a user at computer 12 may use a browser or other application to request content from content server 22e. The request may be sent from computer 12 via land network 16 to data system 20. At data system 20, the request can be received by a web application running on a front-end server 26. The front-end server 26 then processes the request and retrieves the appropriate content from content server 22e. In another instance, a user may wish to modify certain attributes or properties of the content. In this case, the front-end server 26 receives the request via land network 16 and, then, performs certain operations on the data stored in the content servers. The front-end servers 26 may also carry out other operations incident to the processing and communicating of web requests. For example, the front-end servers may authenticate and/or authorize user information that is sent along as a part of a request from a browser or application at computer 12.

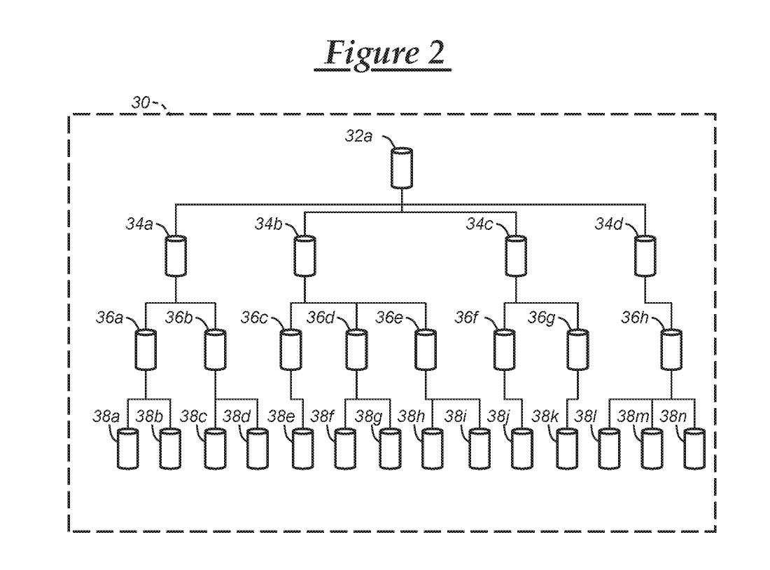

In one embodiment, the data system 20 can operate to provide an enumeration utility. In certain embodiments, the enumeration utility facilitates the execution of commands on one or more selected data objects. For example, a file system user may desire to carry out certain commands on certain data objects. To do so, the user may write a program that will traverse a set of data objects, such as a set of data objects 30 (FIG. 2), to locate the selected data objects and, upon locating such objects, the commands may be carried out. Since data object traversal of this nature may be desired in many instances, the enumeration utility may, in some embodiments, provide a convenient mechanism for a user who desires to carry out certain commands on certain data objects. Simply, the enumeration utility, in some embodiments, allows for a user to select certain data objects and certain commands and, subsequently, the utility carries out those commands on the selected data objects through use of front-end servers 26, application servers 24, and/or content servers 22. This can include the locating of the selected data objects and the executing of the selected commands on those selected data objects.

In one embodiment, the enumeration may identify a set of data objects through the detection of an established connection to a file system. Then, a graphical user interface may display certain command identifiers and certain data object identifiers relating to the identified set of data objects thereby enabling a user to select certain commands and data objects. After receiving such input from the GUI, the enumeration utility may evaluate a set of data objects corresponding to the input and, based on the evaluation, carry out the command(s) on one or more selected data objects as indicated by the input.

The graphical user interface portion of the utility may be stored and executed on a front-end server. In such a case, a user may operate the utility from a remote computer, such as computer 12, via a browser, a client application, a remote desktop connection, a virtual private network (VPN) connection, or other remote networking means. Or, as will be discussed more below, the graphical user interface may be stored and/or executed on a client computing device located at a remotely located facility or office, such as computer 12 which may be located at a workplace or remote location 18a or 18b.

The data system 20 may include other components, computers, servers, or devices that are not shown in the illustrated embodiment. For example, data system 20 may include a set of computers or devices that are dedicated for input/output operations received from remote devices via land network 16. Such input/output devices may include a set of load balancers that operate to balance data requests or operations for the servers of data system 20. Other devices may include: logging devices that are dedicated to logging the operations of the data system and/or the input/output operations performed by the farm; backup devices that create and maintain backup versions of software, firmware, or data used in the data system; and an authentication/authorization server that authenticates a user and/or that determines which data objects, programs, or devices a user has access to.

With reference to FIG. 2, there is shown an embodiment of a set of data objects 30 organized in a hierarchical structure. The hierarchical structure contains numerous levels, with object 32a representing the top-most level and objects 38a-n representing the bottom-most level. In some embodiments, each of the data objects are of various data types with the data type depending on the hierarchy level. The data types may be defined in a number of ways; for example, one data type may be a database file, another may be a text file, and another may be a collection of database files or text files.

In one embodiment, the set of data objects 30 may be a SharePoint™ farm with farm object 32a representing a farm object. Farm object 32a contains four web applications 34a-d; those web applications 34a-d contain eight content databases 36a-h; and those eight content databases contain fourteen sites 38a-n. It should be appreciated that the content databases 36a-h may contain any number of site collections. One skilled in the art will appreciate that a SharePoint™ content database refers to a database file whereas a SharePoint™ site collection refers to a collection of sites and, generally, a content database may include one or more site collections. For simplicity, the following description is discussed with a one-to-one relationship between the content databases and the site collections, unless specified otherwise. It should be appreciated that this is one embodiment of a set of data objects and that any number of different sets of data objects could be used with any of a number of differing structures. For example, the set of data objects 30 may comprise any number of different types of data objects and may include any number of hierarchy levels or data objects.

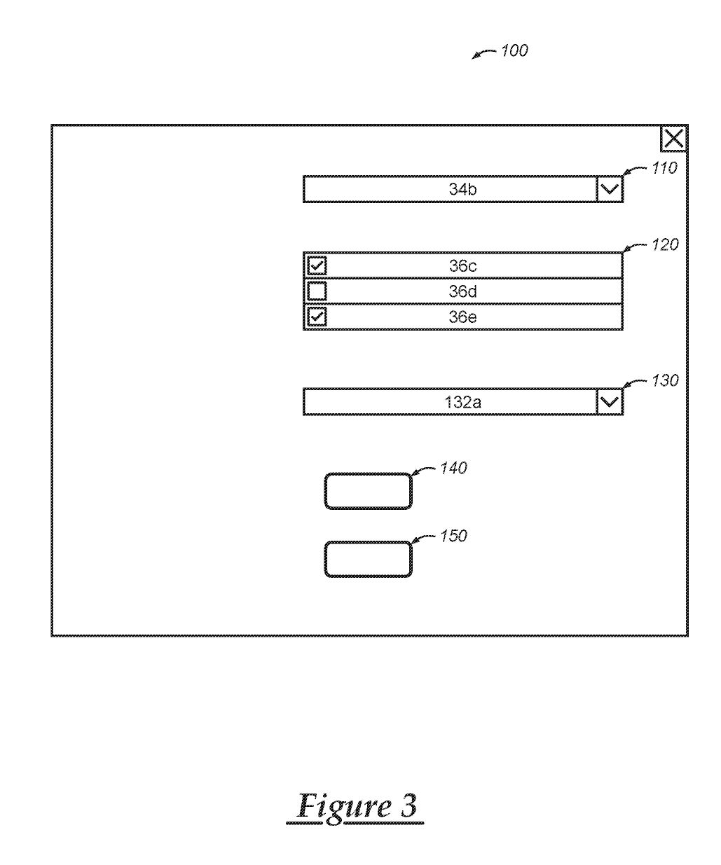

With reference to FIG. 3, there is shown a graphical user interface (GUI) 100 that is used in connection with at least some embodiments of the method provided herein. The GUI 100 is shown as including a data object selection portion which comprises a drop-down menu 110 for selecting a web application 34 and a checklist 120 for selecting one or more content databases 36c-e. As shown in the illustrative embodiment, web application 34b (“Web App 34b”) along with content databases 36c and 36e, have been selected. Additionally, the GUI 100 also contains a command drop-down menu 130 (“Command 132a” is selected as shown in the illustrative embodiment), as well as an options button 140 and a run or submit button 150.

Although the illustrative embodiment shows specific input selection objects, such as drop-down menus, checklists, and buttons, it should be appreciated that any input objects may be used. In other embodiments, it may be desirable to select more than one web application or command at a time and, thus, a checklist input object(s) may be more suitable in such embodiments than a drop down menu. The corollary is true for the content database checklist 120; if only one content database may be selected at a time, a drop down menu or a radio button object may be more suitable and, thus, used in place of the checklist 120. It should be appreciated that any suitable input means may be used.

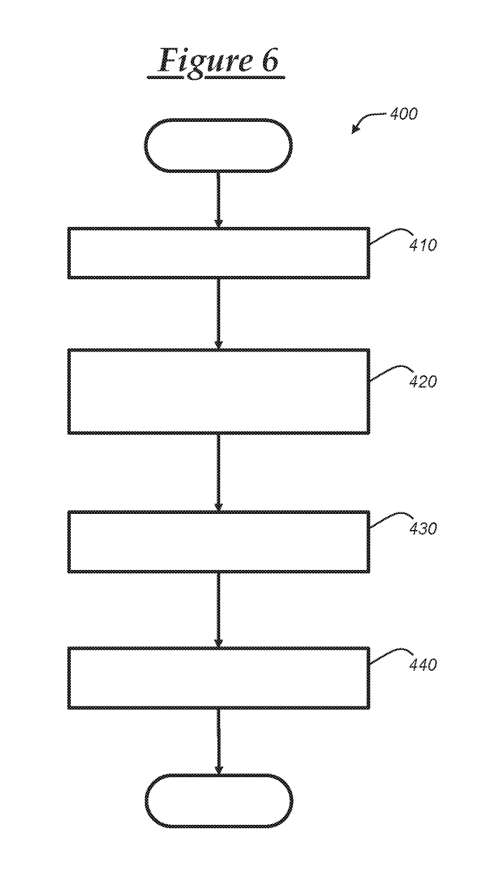

As mentioned above, in some embodiments and depending on the specific implementation, the GUI may be part of the enumeration utility or may be separate. In either case, the GUI 100 can be installed on a computer 12 or may be installed on an application server 24a-f at a server 20. As will be described in greater detail below with reference to FIG. 6, the GUI provides an interface between a user and the enumeration process thereby allowing the user to select certain data objects, sets of data objects, commands, and/or other configurable options that will be used for carrying out the enumeration job.

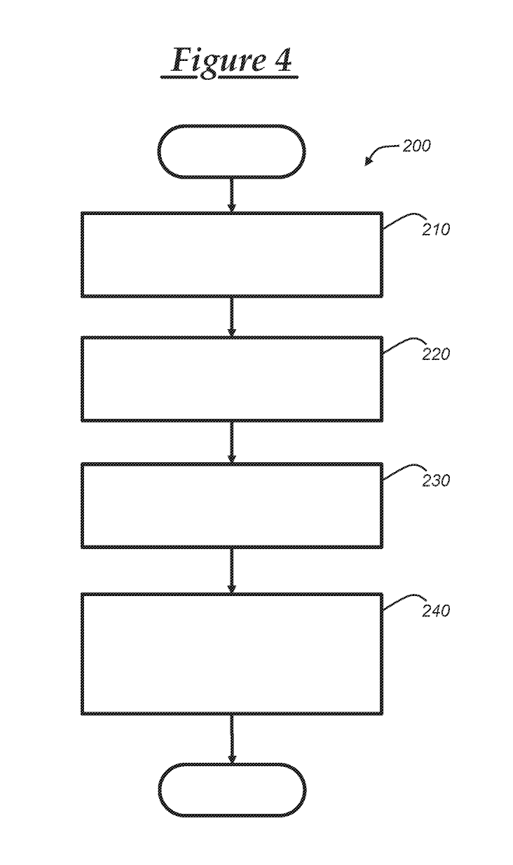

With reference to FIG. 4 there is shown an embodiment of a method 200 for carrying out one or more commands on one or more selected data objects. Generally, the method 200 includes the steps of: determining a hierarchy of a set of data objects (step 210); receiving an object selection identifying one or more selected data objects (step 220); receiving a command input, wherein the command input identifies one or more commands to be carried out on the one or more selected data objects (step 230); and carrying out the command(s) on the one or more selected data objects by traversing the set of data objects based on the determined hierarchy of the set of data objects (step 240). The method 200 may be executed on one or more front-end servers 26, application servers 24, computers 12, or other devices that may be configured to carry out the method. Moreover, the method 200 may be carried out as part of an enumeration utility and/or in conjunction with a graphical user interface (GUI), such as GUI 100. The method 200 and GUI 100 may be, but do not need to be, carried out on the same device or at the same location. For example, the GUI 100 could be executed by a computer 12 and the method 200 could be carried out by an application server 24.

The method 200 begins with step 210 by determining a hierarchy of a set of data objects. The set of data objects may be part of a database system or SharePoint™ file system. As mentioned above with reference to FIG. 2, the set of data objects 30 is one such example, with data object or farm object 32a at the top-most level and data object or sites 38a-n at the bottom-most level. In one embodiment, the hierarchy of the set of data objects 30 may be determined through recalling one or more parent objects, such as farm object 32a, and then traversing the children of those objects, and so on, until all children objects of those parent objects have been identified or traversed. As used herein, “traversing” or its other forms includes iterating and is not meant to be limited to any specific traversal or iteration algorithm or methodology.

Or, in other embodiments, it may be desirable to only traverse a part of the set of data objects, such as certain levels, or certain objects. For example, a top level and a bottom level may be specified either via input by a user operating a GUI 100 or may be predetermined. In such a case, the traversal algorithm may be set to start at all objects contained at the top level that was specified and only traverse down to the bottom level that was specified. In yet another embodiment, a set of objects may be specified, such as objects 34a and 34c, and, thus, only those specified objects will be traversed to identify their underlying structure. In one embodiment, the objects may be specified based on a file system connection. For example, a user at computer 12 may have established a connection and/or session with a web application on front-end server 26. The connection may involve access to certain data objects, such as, for example, a SharePoint™ connection to certain web applications 34. Thus, only these data objects will be traversed.

In some embodiments, the set of data objects 30 may be arranged in a tree data structure. In such a case, any from a number of tree traversals or tree searches may be used for determining the hierarchy or structure of the set 30. For example, an in-order traversal algorithm may be used. Other examples include pre-order or post-order traversal algorithms. In other embodiments, the set of data objects 30 may be a linear data structure, such as a list or array. Or, the set of data objects 30 may be any sort of graph, such as a directed graph. In such embodiments, any suitable graph, list, or array traversal algorithm may be used to determine the structure of the set of data objects 30.

During the traversal of the set of data objects, information obtained or based on the traversal may be stored in a memory medium. For example, upon traversing to each node, information pertaining to the node may be obtained, determined, or identified, and stored in memory. Then, when the traversal of the set of data objects 30 is completed, a data file (or set of data files) may comprise a representation of the hierarchical structure of the set of data objects. Thus, according to one embodiment, in future executions of method 200, the traversal of the set of data objects 30 may not be necessary since the data file already contains the hierarchical structure of the set 30; instead, the data file may be recalled from memory.

In other embodiments, the set of data objects may not need to be traversed to determine the hierarchy. For example, the set of data objects may be stored in a metadata table in a database at content servers 20. Thus, the metadata table may be queried to determine the hierarchy of the set of data objects. In other embodiments, a traversal may have already been carried out in a previous execution or by another method or program that uses or is associated with the set of data objects 30. For example, as mentioned above, a data file may be created upon a first traversal of the set of data objects 30. Thus, the data file may be recalled to determine the hierarchy instead of carrying out another traversal. In such an embodiment, it may be desirable to track changes in children objects and/or changes in relationships between objects and, upon detecting such change(s), a traversal can be carried out such that a data file may be created or updated to reflects the change(s). The method then proceeds to step 220.

In step 220, an object selection identifying one or more selected data objects is received. The object selection or the object selection input may identify objects that will be processed according to one or more commands or instructions, as will be explained below in step 240. In one embodiment, an input from a user is received that contains an object selection identifying certain data objects. For example, the input may be received via a GUI, such as GUI 100. The object selection may directly identify one or more data objects, such as any of those in the set of data objects 30, or may indirectly identify certain data objects, such as through specification of a certain hierarchical level. In one embodiment, a user of GUI may have the option to select a hierarchical level as opposed to certain objects. For example, the user may select “Content Databases” and, thus, effectively the user has selected all content databases 36.

In another example, and as shown in FIG. 3, the GUI may allow for the selection of a parent object and one or more children of that parent. A parent data object is any data object that is capable of having at least one child data object, which is a data object that is located at a lower hierarchical level in the hierarchical structure and that is associated with the parent object. In such an example, a user may be presented with a GUI 100 that initially has nothing selected in drop-down menu 110 and nothing populated in checklist 120. Then, upon a user selecting a parent object, such as a web application, from menu 110, checklist 120 may be populated based on the selected web application. For example, if a user selects web application 34b, then the checklist object 120 will populate with the children of object 34b, which are objects 36c-e, as shown in FIG. 3. Thus, a user may select certain content databases, such as content databases 36c-e. The method proceeds to step 230.

In step 230, a command input to be carried out on the one or more selected data objects is received. The command input is a message or other data that indicates or identifies one or more commands. In one embodiment, the command input may be a memory reference to a set of commands, such as a pointer to a memory address where a set of commands resides. In another embodiment, the command input may actually include the set of commands to be executed. In yet another embodiment, the command input may include an identifier that is used to locate a command or set of commands. The command input may be received as a part of the same message or data signal as the object selection.

As mentioned above and as will be further described in step 240, the command(s) will be executed with respect to the selected data objects (step 220). The command(s) may be scoped to certain types of data objects, such as content databases or sites. Upon receipt of the command input, data or other information pertaining to the command input may be stored in a memory medium. It should be appreciated that steps 210-230 may be carried out in any order or concurrently with one another. The method 200 proceeds to step 240.

In step 240, the one or more commands are carried out on the one or more selected data objects by traversing the set of data objects based on the determined hierarchy. In one embodiment, the selected data objects may comprise content databases 36c-e. In such an embodiment, those objects may be recalled or accessed and the one or more commands, as identified in the command input, may be executed on those objects. In some embodiments, the commands may be configured to be carried out on all children objects of the selected objects as well and, thus, the selected objects will be traversed and the commands will be executed on these children objects. In other embodiments, the commands may be configured to be carried out on the parent objects of such selected objects. In some embodiments, a command set may be identified in the command input and the command set may include different commands for different objects, such as one group of commands for content databases 36 and another group of commands for sites 38. The method 200 then ends.

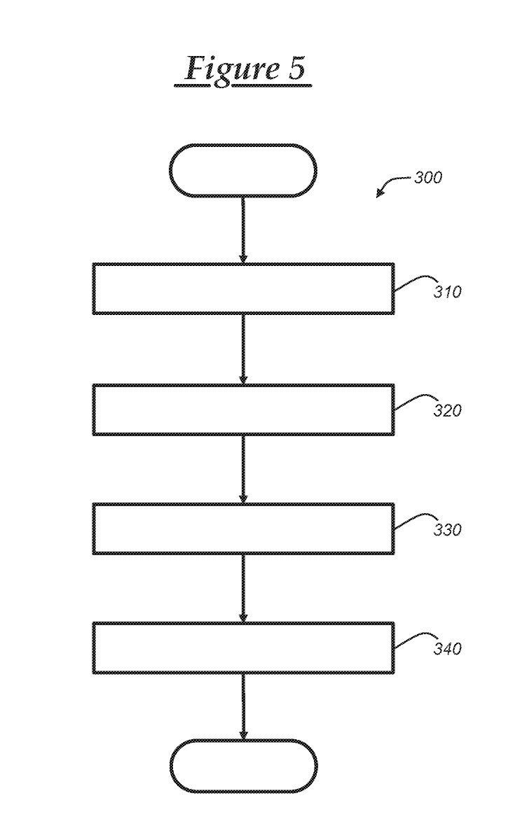

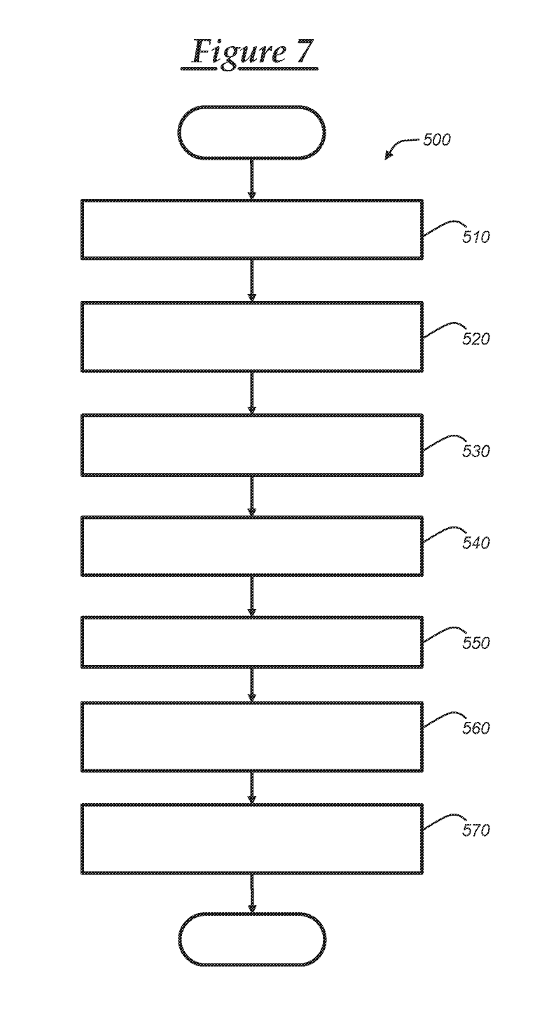

With reference to FIGS. 5 to 7, there is shown separate parts of a detailed embodiment of an enumeration utility. The detailed embodiment comprises three parts: locating and identifying code assemblies or commands to be used in an enumeration job (FIG. 5); providing a graphical user interface (GUI) for configuring and submitting an enumeration job (FIG. 6); and executing the enumeration job by carrying out one or more commands on one or more selected data objects (FIG. 7). In one embodiment, a user may initiate the enumeration utility which may begin by performing a method 300 to locate code assemblies, as illustrated in FIG. 5. Concurrently, method 400, as illustrated in FIG. 6, may be carried out thereby allowing the user to select certain data objects and commands as input to the enumeration process. Then, upon a user configuring certain input via the GUI, the user may submit the enumeration job via selecting a “Run” or “Submit” button. The enumeration job submission may initiate a method 500 for carrying out the selected commands on the selected data objects. During or after operation of the enumeration job, results may be stored in memory on a computing device and/or presented to the user.

The methods 300, 400, and 500 may be carried out or executed on the same or different computing devices. For example, the method 300 and the method 400 may be carried out by a computer 12 or a front-end server 26, and the method 500 may be carried out by an application server 24. As those skilled in the art will appreciate, there are numerous different implementations in which the following methods may be carried out.

With reference to FIG. 5, there is shown an embodiment of a method 300 for locating and identifying code assemblies or commands that may be carried out on one or more data objects. The method 300 begins with step 310, where a computer environment is searched for code assemblies. The computer environment may be a set or group of files and/or directories located on a memory. In one embodiment, the enumeration utility may specify a group of directories where code assemblies are to be located. In such an embodiment, the enumeration utility may parse the directories for code assemblies. The code assemblies can be identified via by their file extension, such as “.dll” (dynamically-linked library) or “.exe” (executable), if they have a file extension, or may be identified from any of a number of other ways. The method then continues to step 320.

After locating one or more code assemblies, in step 320, the code assemblies are inspected for one or more commands. In one embodiment, a code assembly may contain certain commands that are to be carried out for certain data objects, data types, or certain hierarchical levels. For example, certain types of data objects or data objects located at certain hierarchical levels in the hierarchy may have different attributes. In such a scenario, certain commands may only be effective or workable on certain types of data objects or data objects located at certain levels. It may be desirable in such an instance for the code assemblies to implement certain interfaces that are scoped to either certain data types or data hierarchical levels. These scoped interfaces may be predefined by a file system, such as SharePoint™, or may be defined by a user or other configuring entity. The method then continues to step 330.

In step 330, after inspecting each code assembly, each command or each group of commands may be resolved to a certain scope, data type, or hierarchical level. This information may be useful, at least in some embodiments, to the graphical user interface (GUI) 100 in that it will be able to filter the commands in the drop-down menu 130 that are selectable for a certain data type or level as selected in input objects 110 and 120. The method then continues to step 340.

In step 340, after the scope is resolved for each command or group of commands, then information may be sent or otherwise used by a graphical user interface, such as GUI 100. The information may include identifying information, such as a title, name, or other identifier of one or more commands. As will be described in greater detail below, the commands may then be displayed at input object 130 for selection by a user of the GUI 100. Depending on the specific embodiment, the commands enumerated in the drop-down menu 130 may differ depending on the data objects selected in input objects 110 and 120. The method 300 then ends.

With reference to FIG. 6, there is a method 400 of providing a graphical user interface for selecting input and/or configuring options for an enumeration job (see FIG. 7 for an embodiment of the enumeration job). The method generally includes the steps of detecting a connection to a file system, such as SharePoint™ (step 410); providing data objects via the GUI based on the detected connection (step 420); populating an input object at the GUI with commands based on the selected data objects (step 430); and receiving an enumeration job submission from a user via the GUI (step 440). The method 400 may be carried out on a computer 12, an application server 26, or another computing device located at data system 20 or other remote location 18.

The method 400 beings with step 410 where a connection to a file system is detected. For example, in an embodiment using Microsoft™ SharePoint™ as the file system, a connection may be detected through use of Microsoft™ SharePoint™ libraries or namespaces. In one example, as those skilled in the art will appreciate, a known library may be incorporated through use of a reference to such a library. These libraries may be stored on the computer as part of a file system server, such as SharePoint™ Server, and may be included with the file system and/or may be extensions that were developed for the file system. The method 400 may include a step where a method or function included in a referenced library is called or invoked. The method or function may, in effect, provide information pertaining to a file system connection, such as a connection to a certain SharePoint™ web application. The method then continues to step 420.

In step 420, one or more data objects are provided to the user via the GUI 100 based on the detected connection to the file system. In one embodiment, one or more data objects are identified based on the detected connection or through querying a file system using the detected connection. For example, a request to retrieve identifiers of data objects that are accessible via the detected connection may be sent to a front-end server 26. The front-end server may then send the identifiers of the data objects back to the GUI 100, which can then display the identifiers.

In some embodiments, upon the detection of the connection, one or more parent data objects may be identified and/or evaluated based on the connection. A parent data object is any data object that is capable of having at least one child data object, which is a data object that is located at a lower hierarchical level in the hierarchical structure and that is associated with the parent object. For example, the connection may provide access to multiple web applications 34 and, thus, the multiple web applications 34 may be identified and/or evaluated by the front-end servers 26, application servers 24, and/or content servers 22. The identifiers of the parent objects may be sent back to the GUI 100. Then, the drop-down menu 110 may be populated with identifiers of these web applications that was received in response to the request (see step 510 of FIG. 5). Or, in another embodiment, if the detected connection includes only a single web application (or other top-level object), then that data object may be displayed and automatically selected in menu 110 at the GUI.

Additionally, there may be one or more additional input objects to allow for the selection of other data objects, such as input objects allowing for the selection of children data objects of the data objects to which the connection is made. In one embodiment, upon a user selecting a parent object from the menu 110, such as web application 34b, the child data object identifiers may be populated in checklist 120. The child data object identifiers may be sent along with the parent data object identifiers. Or, after a parent object is selected from the menu 110, the GUI 100 may send a request to fetch the child data objects of the selected parent object. For example, if the connection provides access to web application 34b, then the identifiers of data objects 34b and 36c-e may be sent to the GUI 100 and displayed at checklist 120. In another example, there may be other data input objects for selecting other objects, such as the children 38e-i of content databases 36c-e. The method then continues to step 430.

In step 430, one or more commands are provided at the GUI based at least in part on the detected connection or on user-selected data objects. In one embodiment, the commands may depend, at least in part, on the connection, such as the type of connection, the type of data objects associated with the connection, and/or other attributes of the connection. Additionally, or alternatively, the commands may be directed to certain web applications or other data objects. Thus, when a connection is detected and one or more commands are identified by the enumeration utility (see FIG. 5), the commands may be filtered based on their suitability, scope, or interfacing capabilities with the data objects of the detected connection. Or, the commands may be filtered based on the type of data objects that are selected or accessible via the detected connection. In one embodiment, a drop-down menu 130 may be populated with one or more commands or groups of commands thereby allowing a user to select a command. For example, as shown in the illustrated embodiment of FIG. 3, “Command 132b” is selected.

In one example, a user may have the option to select certain levels of data objects (not shown in FIG. 3), such as a drop-down menu listing all available levels. Upon a selection of one of the levels, the drop-down menu 130 may be filtered to only those commands that are executable on the selected hierarchy level. The method then continues to step 440.

In step 440, a submission request input is received from a user via the GUI. The submission request input may be generated in response to the operation of an input object, such as button 150. The input may include all the configured options and selected data objects in the GUI and/or other information gathered by the enumeration utility, such as information regarding the commands and/or the detected connection. The input may be sent in a message to an enumeration process, which may then be carried out in response to and based on the input. The method 400 then ends.

With reference to FIG. 7, there is shown a method 500 of carrying out one or more commands on one or more data objects. As mentioned above, in some embodiments, the method may be part of an enumeration utility that also includes a graphical user interface. In such embodiments, the method 500 may work in conjunction with method 300 (FIG. 5) and/or method 400 (FIG. 6), and may operate to process an enumeration job that is submitted by a user via a GUI (see step 440 in FIG. 6). The method generally comprises the steps of: determining and/or evaluating a target set of data objects (steps 510 and 520); sending information pertaining to the target set of data objects to a GUI (step 530); receiving an enumeration job submission from the GUI (step 540); carrying out an enumeration job based on the enumeration job submission (steps 550 and 560); and recording results or other status information pertaining to the enumeration job (step 570). The method 500 may be carried out on one or more application servers 24, front-end servers 26, computers 12, other computing devices, or any combination thereof.

In step 510, one or more parent data objects or subsets of data objects are identified. These data objects may be a set of data objects 30 or a subset thereof. The identification may be made based on receiving a message from a front-end server that has an established a file system connection. The established connection may be made to a computer 12 that is operated by a user and, additionally, the established connection may be associated with one or more data objects, such as certain web applications 34. Thus, in one example where there is an established connection between a user at computer 12 and a web application 34 via front-end server 26, the web application and its children may be identified. In another embodiment, a request from a GUI 100 may be received and, subsequently, target data objects may be identified based on the request. The method continues to step 520.

In step 520, the identified objects may be evaluated to determine a structure or hierarchy of the identified objects. The structure or hierarchy of the identified objects may consist of a tree structure, or may comprise of a set of relationships between the identified data objects and/or other data objects. In one embodiment, an application server 24 may traverse the identified data objects using any of a number of graph traversal algorithms, such as those described above with reference to step 210 of method 200 (FIG. 4). In other embodiments, the application server 24 or front-end server 26 may simply query the content servers 22 for the children of the identified data objects. For example, if the identified data objects are web applications 34b and 34c, then the content databases 36c-g and the sites 38e-k may be returned. Or, in another embodiment, only the first generation of children will be returned, such as content databases 36c-g in the present example. The method then proceeds to step 530.

In step 530, data object identifiers are sent to a graphical user interface based on the evaluation. A data object identifier may be a title, name, address, or other information that is used to indicate a certain data object to a user of the GUI. In one embodiment where a connection is established to a web application, identifiers for all content databases that are children of that web application are sent to the GUI. For example, if a user establishes a SharePoint™ connection to web application 34b via front-end server 26d, then identifiers of the content databases 36c-e may be sent to the GUI. As explained above, once the content database identifiers are presented to a user, as shown at input object 120 in FIG. 3, a user may then select certain inputs associated with these identifiers. A user may then, after selecting all desired inputs and configuring certain options via options button 140, submit the enumeration job by, for example, clicking on the “Run” button 150, as discussed above in step 440 of FIG. 6. The method continues to step 540.

In step 540, data object and command selections are received from the GUI. The data object and command selections may be received in a single message, or may be received in separate messages. In one embodiment, the GUI at a computer 12 sends a message to front-end server 26 via land communications network 16. The front-end server may then process the message and obtain data object and command selections. In one embodiment, the selections may comprise identifiers for the data objects and commands. In other embodiments, the selections may comprise the data objects and/or commands themselves. After the message is received, the message, or a part thereof, may be stored in memory at the receiving server, such as front-end server 26e.

The message received may include other information or selections, such as metadata or data reflecting certain user configurations that may have been made via the GUI. For example, a user may press an “Options” button 140, which may then open another GUI window or at least include more input objects that enable a user to configure certain options. The configurable options may be dependent on the selected data objects or commands. One example of a configurable option may be to enable a user to enter the maximum number of threads that the enumeration job should use when carrying out the commands (“thread maximum”). Another option may be a toggle input object that indicates whether the selected commands should also be carried out on all the children of the selected objects. There are numerous other possible options, as those skilled in the art will appreciate. The method continues to step 550.

In steps 550 and 560, the one or more commands are carried out on the one or more data objects. In one embodiment, the set of data objects is traversed based on the evaluation (step 520) to locate, recall, or identify the one or more selected data objects. In another embodiment, the selected data objects are recalled based on their memory addresses, via a searching algorithm carried out by the application servers, or other location/identifying process(es). Then, one or more commands may be carried out on the selected data objects. As mentioned above, the one or more commands may be scoped to one or more certain hierarchies or levels and, thus, in some embodiments, only those commands that are properly scoped to the hierarchy levels of the selected data objects are carried out.

In one embodiment involving the use of Microsoft™ SharePoint™, the content servers may include content databases associated with certain web applications included in a farm. For example, certain site collections may be associated with certain content databases and, thus, may reside in the same file on the content server. In at least one embodiment, the content databases may comprise of a single file and, thus, it may be desirable to execute the commands for all data objects located in a single content database using a single thread, as illustrated in step 550. In one embodiment, there may be multiple threads executed at the same time, with each thread operating on or with a content database and where no two threads running at the same time are operating on or with a content database of another thread. In some embodiments, the maximum number of threads may be set by a user of the GUI 100 via the options button 140, or may be set by an author of the commands.

In step 560, upon a thread finishing, a new thread for another content database may be started. If there are no more content databases or data objects that need to be processed, then a new thread will not be started. In other embodiments, the execution of the commands on the selected data objects may be carried out using different processing steps. Upon all threads finishing, the method 500 may proceed to step 570.

In step 570, results and/or statuses of the enumeration job may be written to a file or displayed via the GUI 100 or other user interface. The results and/or statuses may be rendered or written to a file during the enumeration job or after completion of the enumeration job. The results and/or statuses may include details regarding the job itself, such as the progress of the enumeration job. Error messages may also be stored as part of the results or presented during the enumeration job to the user via GUI 100. Additionally, the results of the commands, whether be it output generated as part of the commands or results generated by the enumeration process itself, may be outputted to a file, such as a Microsoft™ Excel™ file. The results may be specific to the commands and generated by the commands themselves. Or, the results may be part of the enumeration process by which the enumeration process determines whether the one or more commands successfully executed and completed on each of the selected data objects. The method 500 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive or. Put differently, the phrase “A, B, and/or C” includes: “A”; “B”; “C”; “A and B”; “A and C”; “B and C”; and “A, B, and C.”

1. A method for carrying out one or more commands on one or more selected data objects contained in a set of data objects, wherein the method comprises the steps of:
determining a hierarchy of a set of data objects, wherein the set of data objects comprises a plurality of data objects that are organized in a hierarchical structure containing one or more hierarchical levels;
receiving an object selection identifying one or more selected data objects;
receiving a command input, wherein the command input identifies one or more commands to be carried out on the one or more selected data objects; and
carrying out the one or more commands on the one or more selected data objects by traversing the set of data objects based on the determined hierarchy of the set of data objects.

2. The method of claim 1, wherein each of the data objects are located at one of the hierarchical levels, and wherein a data type of each of the data objects varies based on the hierarchical level that the data object is located at.

3. The method of claim 1, wherein the hierarchical structure is a tree structure with at least one root data object and at least one leaf data object.

4. The method of claim 1, further comprising the step of detecting an established connection to a file management system.

5. The method of claim 4, wherein the established connection comprises a connection to a certain subset of data objects of the set of data objects, and wherein the determining step is made based on the certain subset of data objects.

6. The method of claim 5, wherein the established connection is established between a client computing device and a content server, wherein the content server comprises the certain subset of data objects of the set of data objects.

7. The method of claim 6, wherein one or more computing devices are interpolated between the client computing device and the content server, wherein at least one of the one or more computing devices is a front-end server or an application server.

8. The method of claim 1, wherein the object selection is made by a user via a graphical user interface.

9. The method of claim 8, wherein the command input is generated based on one or more command selections made by a user at the graphical user interface.

10. The method of claim 1, wherein each of the selected data objects are located in one of a plurality of data files, wherein the one or more commands are carried out in one or more threads, and wherein each of the threads carries out the one or more commands on the selected data objects contained within one of the data files whereby all selected data objects contained in a single data file are carried out in a single thread.

11. The method of claim 10, wherein the one or more threads are executed in a concurrent or multithreaded manner such that at least two of the threads may be executed out at the same time.

12. The method of claim 11, wherein a thread maximum is specified by a user via a graphical user interface and wherein the carrying out step does not execute more than the thread maximum amount of threads at a single time.

13. A method for carrying out a command on one or more selected data objects contained in a set of data objects, wherein the method comprises the steps of:
identifying a set of data objects based on a connection to a file management system, wherein the set of data objects comprises a plurality of data objects that are organized in a hierarchical structure containing a plurality of hierarchical levels and wherein the set of data objects are accessible via the file management system;
evaluating the set of data objects to determine one or more hierarchical levels of the data objects comprising the set of data objects;
receiving an object selection input indicating one or more selected data objects, wherein the object selection input specifies either at least one data object or at least one of the plurality of hierarchical levels;
receiving a command input indicating a command to be carried out on the selected data objects, wherein the selected data objects are either those data objects specified in the object selection input or those data objects included in the hierarchical level specified in the object selection input; and
carrying out the command on the one or more selected data objects by traversing the set of data objects based on the one or more hierarchical relationships.

14. The method of claim 13, further comprising the step of detecting the connection to the file management system, wherein the connection is established between a client computing device and a content server.

15. The method of claim 14, wherein the database server comprises one or more databases, wherein each of the databases comprises one or more data files, and wherein each of the databases and data files constitute at least some of the plurality of data objects contained in the set of data objects.

16. The method of claim 13, further comprising the step of receiving a first data object selection from a graphical user interface, wherein the first data object selection comprises at least one parent data object, wherein the at least one parent data object includes one or more children data objects, and wherein the set of data objects is based on the first data object selection.

17. The method of claim 16, wherein the set of data objects comprises one or more of the selected parent data objects and all children data objects of the selected parent data objects.

18. The method of claim 17, further comprising the step of sending one or more identifiers of one or more children data objects of the selected parent data objects to the graphical user interface.

19. The method of claim 18, wherein the selected data objects of the object selection input include one or more of the children data objects.
